(19) United States
(12) Patent Application Publication
(10) Pub. No.: US 2022/0110476 A1
(43) Pub. Date: Apr. 14, 2022

(54) Self-Warming Bottle Assembly

(71) Applicant: Sarah D. Hackney, Crosby, TX (US)

(72) Inventor: Sarah D. Hackney, Crosby, TX (US)

(21) Appl. No.: 17/065,983

(22) Filed: Oct. 8, 2020

(51) Int. Cl. A47J 36/24; A61J 9/04; A47J 36/30; A61J 9/00

(52) U.S. Cl. CPC A47J 36/2411; A61J 9/04; A61J 2200/42; A61J 9/001; A47J 36/30

(57) ABSTRACT

A self-warming bottle assembly includes a bottle that may contain a fluid. The bottle has a chamber that is fluidly discrete from an interior of the bottle. A warming media is positioned within the chamber. Thus, the warming media selectively warms the fluid in the bottle. A sleeve is removably positioned around the bottle and the sleeve may be manipulated. The sleeve inhibits the warming media from warming the fluid.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bottle devices and more particularly pertains to a new bottle device for facilitating hands free warming of a fluid.

### BRIEF SUMMARY OF THE INVENTION

An embodiment of the disclosure meets the needs presented above by generally comprising a bottle that may contain a fluid. The bottle has a chamber that is fluidly discrete from an interior of the bottle. A warming media is positioned within the chamber. Thus, the warming media selectively warms the fluid in the bottle. A sleeve is removably positioned around the bottle and the sleeve may be manipulated. The sleeve inhibits the warming media from warming the fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a self-warming bottle assembly according to an embodiment of the disclosure.

FIG. 2 is an exploded perspective view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 1 of an embodiment of the disclosure.

FIG. 5 is a back view of an embodiment of the disclosure.

### DETAILED DESCRIPTION OF THE INVENTION

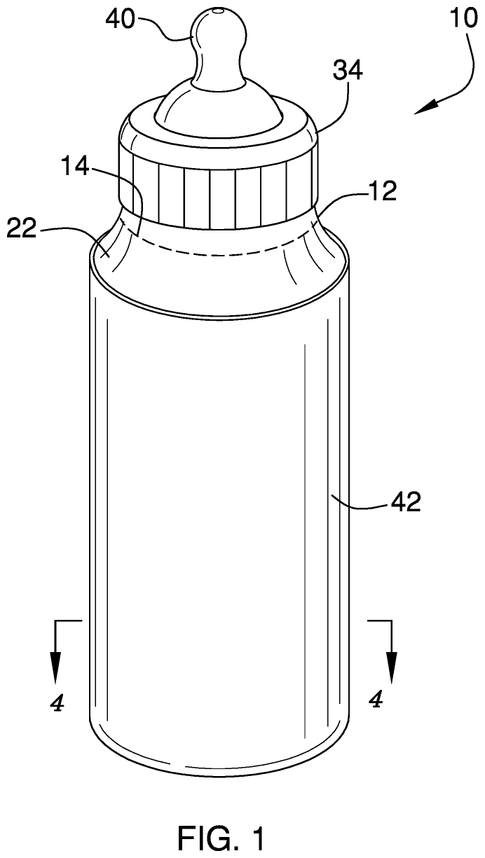

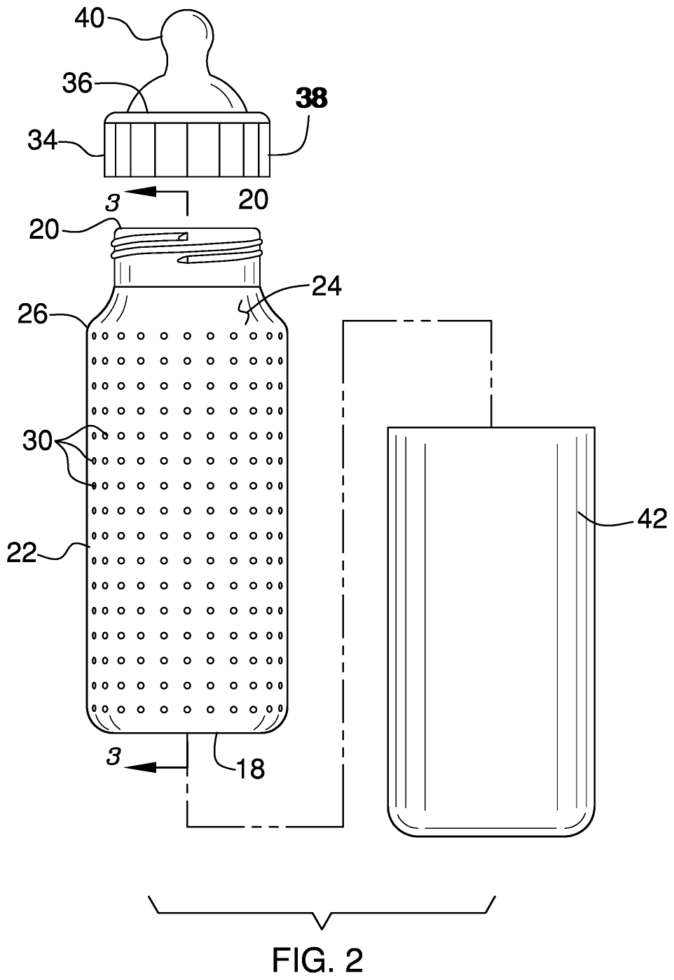

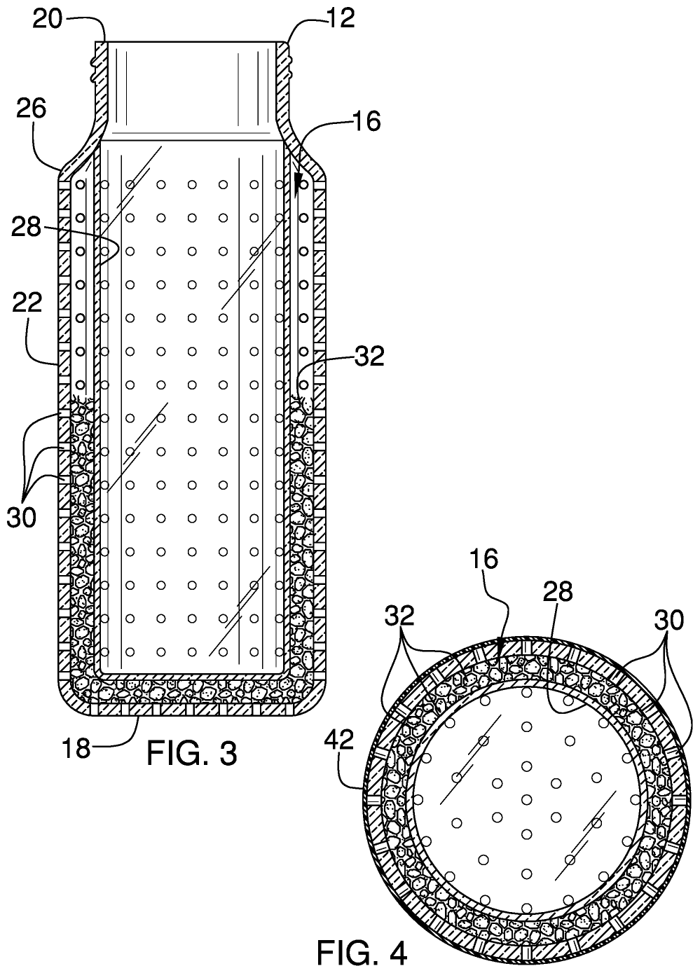

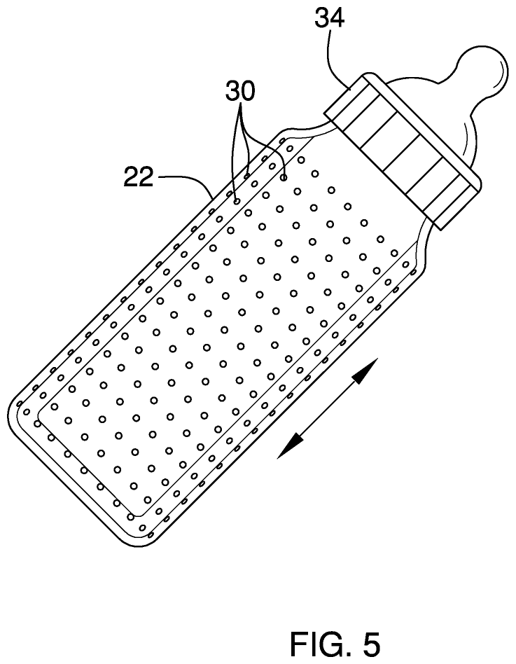

With reference now to the drawings, and in particular to FIGS. 1 through 5 thereof, a new bottle device embodying the principles and concepts of an embodiment of the disclosure and generally designated by the reference numeral 10 will be described.

As best illustrated in FIGS. 1 through 5, the self-warming bottle assembly 10 generally comprises a bottle 12 that may contain a fluid 14. The bottle 12 has a chamber 16 that is fluidly discrete from an interior of the bottle 12. The bottle 12 has a bottom end 18, a top end 20 and an outer wall 22 extending therebetween. The top end 20 is open into an interior of the bottle 12. The bottle 12 may be comprised of a translucent material. Moreover, the bottle 12 may be comprised of a Bisphenol A free material. The fluid 14 may be baby formula or the like.

The outer wall 22 has an outer surface 24 and the outer surface 24 is threaded adjacent to the top end 20. The outer wall 22 tapers inwardly toward the top end 20 to define a shoulder 26 on the bottle 12. The bottle 12 has an inner wall 28 that is spaced from the outer wall 22. Thus, the chamber 16 is defined between the inner wall 28 and the outer wall 22. The inner wall 28 extends downwardly from the shoulder 26. The outer wall 22 has a plurality of apertures 30 extending into the chamber 16. The apertures 30 are spaced apart from each other and are distributed on the outer wall 22.

A warming media 32 is provided. The warming media 32 is positioned within the chamber 16. Thus, the warming media 32 selectively warms the fluid 14 in the bottle 12. The warming media 32 is comprised of an oxygen reacting material. Thus, the warming media 32 generates heat when the warming media 32 is exposed to air passing through the apertures 30. The warming media 32 may comprise iron powder, activated charcoal, sodium chloride and vermiculite. The warming media 32 may generate a maximum temperature of approximately one hundred twenty degrees Fahrenheit.

A cap 34 is removably coupled to the top end 20 of the bottle 12. The cap 34 has a top wall 36 and a peripheral wall 38. The peripheral wall 38 threadably engages the outer surface 24 of the outer wall 22. A nipple 40 is coupled to the top wall 36 of the cap 34 and the nipple 40 may be sucked. The nipple 40 is in fluid 14 communication with an interior of the bottle 12 to facilitate the fluid 14 to be drunk. The nipple 40 may be a baby bottle nipple or the like.

A sleeve 42 is removably positioned around the bottle 12 and the sleeve 42 may be manipulated. The sleeve 42 covers the outer surface 24 of the outer wall 22 between the shoulder 26 and the bottom end 18 of the bottle 12. The sleeve 42 additionally covers the bottom end 18 of the bottle 12. The sleeve 42 is comprised of an air impermeable material. Thus, the sleeve 42 inhibits the warming media 32 from being exposed to air. The sleeve 42 exposes the apertures 30 when the sleeve 42 is removed from the bottle 12. Thus, air may pass through the apertures 30 thereby facilitating the warming media 32 to warm the fluid 14 in the bottle 12.

In use, the bottle 12 is filled with the fluid 14 and the cap 34 is placed on the bottle 12. The sleeve 42 is removed from the bottle 12 when the fluid 14 is to be drunk by an infant. The bottle 12 is shaken to agitate the warming media 32. Air passes through each of the apertures 30 and activates the warming media 32. Thus, the warming media 32 warms the fluid 14 in the bottle 12. The warming media 32 facilitates hands-free warming of the fluid 14. Thus, the infant may be held while the fluid 14 is warmed. The fluid 14 is drunk when the fluid 14 is warmed. The bottle 12 is discarded when the fluid 14 is consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A self-warming bottle assembly being configured to warm a fluid, said assembly comprising:
a bottle being configured to contain a fluid, said bottle having a chamber being fluidly discrete from an interior of said bottle;
a warming media being positioned within said chamber wherein said warming media is configured to warm the fluid in said bottle; and
a sleeve being removably positioned around said bottle wherein said sleeve is configured to be manipulated, said sleeve being configured to inhibit said warming media from warming the fluid.

2. The assembly according to claim 1, wherein said bottle has a bottom end, a top end and an outer wall extending therebetween, said top end being open into an interior of said bottle, said outer wall having an outer surface, said outer surface being threaded adjacent to said top end, said outer wall tapering inwardly toward said top end to define a shoulder on said bottle.

3. The assembly according to claim 2, wherein said bottle has an inner wall being spaced from said outer wall to define said chamber, said inner wall extending downwardly from said shoulder.

4. The assembly according to claim 3, wherein said outer wall has a plurality of apertures extending into said chamber, said apertures being spaced apart from each other and being distributed on said outer wall.

5. The assembly according to claim 1, wherein:
said bottle has a plurality of apertures; and
said warming media is comprised of an oxygen reacting material wherein said warming media is configured to generate heat when said warming media is exposed to air passing through said apertures.

6. The assembly according to claim 2, further comprising a cap being removably coupled to said top end of said bottle, said cap having a top wall and a peripheral wall, said peripheral wall threadably engaging said outer surface of said outer wall.

7. The assembly according to claim 6, further comprising a nipple being coupled to said top wall of said cap wherein said nipple is configured to be sucked, said nipple being in fluid communication with an interior of said bottle wherein said nipple is configured to facilitate the fluid to be drank.

8. The assembly according to claim 4, wherein said sleeve covering said outer surface of said outer wall between said shoulder and said bottom end wherein said sleeve is configured to inhibit said warming media from being exposed to air, said sleeve exposing said apertures when said sleeve is removed wherein said sleeve is configured to allow air to pass through said apertures thereby facilitating said warming media to warm the fluid in said bottle.

9. A self-warming bottle assembly being configured to warm a fluid, said assembly comprising:
a bottle being configured to contain a fluid, said bottle having a chamber being fluidly discrete from an interior of said bottle, said bottle having a bottom end, a top end and an outer wall extending therebetween, said top end being open into an interior of said bottle, said outer wall having an outer surface, said outer surface being threaded adjacent to said top end, said outer wall tapering inwardly toward said top end to define a shoulder on said bottle, said bottle having an inner wall being spaced from said outer wall to define said chamber, said inner wall extending downwardly from said shoulder, said outer wall having a plurality of apertures extending into said chamber, said apertures being spaced apart from each other and being distributed on said outer wall;
a warming media being positioned within said chamber wherein said warming media is configured to warm the fluid in said bottle, said warming media being comprised of an oxygen reacting material wherein said warming media is configured to generate heat when said warming media is exposed to air passing through said apertures;
a cap being removably coupled to said top end of said bottle, said cap having a top wall and a peripheral wall, said peripheral wall threadably engaging said outer surface of said outer wall;
a nipple being coupled to said top wall of said cap wherein said nipple is configured to be sucked, said nipple being in fluid communication with an interior of said bottle wherein said nipple is configured to facilitate the fluid to be drank; and
a sleeve being removably positioned around said bottle wherein said sleeve is configured to be manipulated, said sleeve covering said outer surface of said outer wall between said shoulder and said bottom end wherein said sleeve is configured to inhibit said warming media from being exposed to air, said sleeve exposing said apertures when said sleeve is removed wherein said sleeve is configured to allow air to pass through said apertures thereby facilitating said warming media to warm the fluid in said bottle.
